(19) United States
(12) Patent Application Publication
(10) Pub. No.: US 2017/0008627 A1
(43) Pub. Date: Jan. 12, 2017

(54) Hybrid Power Supply For Electric Multirotor Rotorcraft

(71) Applicants: Joaquin de Soto, Coral Gables, FL (US); Jorge F. Miranda, Coral Gables, FL (US)

(72) Inventors: Joaquin de Soto, Coral Gables, FL (US); Jorge F. Miranda, Coral Gables, FL (US)

(21) Appl. No.: 15/207,436

(22) Filed: Jul. 11, 2016

Related U.S. Application Data
(60) Provisional application No. 62/190,717, filed on Jul. 9, 2015.
(60) Provisional application No. 62/190,722, filed on Jul. 9, 2015.

(51) Int. Cl. B64C 39/02; H02K 7/18; B64C 27/08; B64D 27/02; G07C 5/00; B64D 33/08

(52) U.S. Cl. CPC B64C 39/024; G07C 5/008; B64D 33/08; B64C 27/08; B64D 27/02; H02K 7/1815; B64C 2201/042; B64C 2201/044; B64C 2201/108; B64C 2201/141; B64C 2201/146; B64C 2211/00; B64D 2027/026

(57) ABSTRACT

Embodiments are directed towards hybrid power supply that provides electric power to a multirotor rotorcraft to extend range or flying time. In one embodiment, an internal combustion engine and fuel tank are provided that interoperate with a battery provided by a commercial multirotor rotorcraft to substantially extend flying time or flying distance.

### BACKGROUND

The current generation of multirotor rotorcraft is typically small and is severely constrained in terms of flying time. The state-of-the-art is in the range of 10-15 minutes of flying time for small size, commercial class quad copters and hex copters. Thus, a flying-time or range extending power solution is desirable; especially one that significantly increase the flying time of relatively, small, inexpensive commercial craft, referred to generically herein as multirotor rotorcraft.

Currently, batteries are exclusively used to power multirotor rotorcraft. However, compared to other energy storage and supply materials, typical batteries have relative low energy densities. For example, the energy density of a lithium-ion battery is in the range of 0.9 to 2.63 Mega Joules (MJ). By contrast, gasoline has an energy density of 32.4 MJ and ethanol has an energy density of 15.6 MJ.

Hybrid electric vehicles (HEVs) have been developed that combine a conventional internal combustion engine (ICE) propulsion system with an electric propulsion system that derives its power from a rechargeable battery combining the efficiency of one with the energy density advantage of the other. However, an equivalent type of hybrid power solution to that used in hybrid vehicles has not been employed for multirotor rotorcraft. Thus, it would be desirable to provide a hybrid power supply that is both small enough and yet powerful enough to work with commercial multirotor rotorcraft.

A key goal of a hybrid power supply for a multirotor rotorcraft is to achieve a sufficient power output, for an allowed vehicle weight. One way to achieve this is to reduce the component count.

Thus, it is with respect to these considerations and others that the present invention has been made.

### SUMMARY OF THE DESCRIPTION

Various embodiments are directed towards a hybrid power supply that provides electric power to a multirotor rotorcraft to extend range and flying time. In one embodiment, an internal combustion engine, induction motor, electronic speed control, computer control system and fuel tank are provided that interoperate with the battery used by a commercial multirotor rotorcraft to substantially extend flying time and flying distance.

To achieve the desired power output density, the component count of the hybrid power supply is reduced by using a single component for dual roles. Instead of having 2 one-way current flow circuits the subject invention innovation has a single multi-direction implementation.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram that illustrates the flow of energy between input or charging elements, a battery and output or load elements in a hybrid power supply for a multirotor rotorcraft;

FIG. 2 is a generalized block diagram that illustrates the operation of a hybrid power supply for a multirotor rotorcraft from the perspective of a control unit;

FIG. 3 illustrates the flow of current during a starting sequence and a charging sequence as performed by an electronic speed control (ESC) as managed by control unit, according to one embodiment of the subject invention;

FIG. 4 is an illustration of an embodiment of a hybrid power supply for a multirotor rotorcraft;

FIG. 5 is a flow diagram that provides an exemplary overall method used by the control unit of a hybrid power supply for a multirotor rotorcraft;

FIG. 6 illustrates an embodiment of a hybrid power supply for a multirotor rotorcraft (HPSM) that includes multiple gensets that connect to output/load elements, such as batteries, via a power bus;

FIG. 7 illustrates one example layout of an integrated circuit board that implements the control unit of a hybrid power supply for a multirotor rotorcraft; and

FIG. 8 illustrates one example of the electronic circuits that implement the control unit of a hybrid power supply for a multirotor rotorcraft.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Multirotor rotorcraft—a relatively small copter with more than a single rotor. A multirotor rotorcraft may be remote controlled by an operator or, as used herein, may refer to a UAV or drone that is capable of autonomous flight.

### Generalized Operation

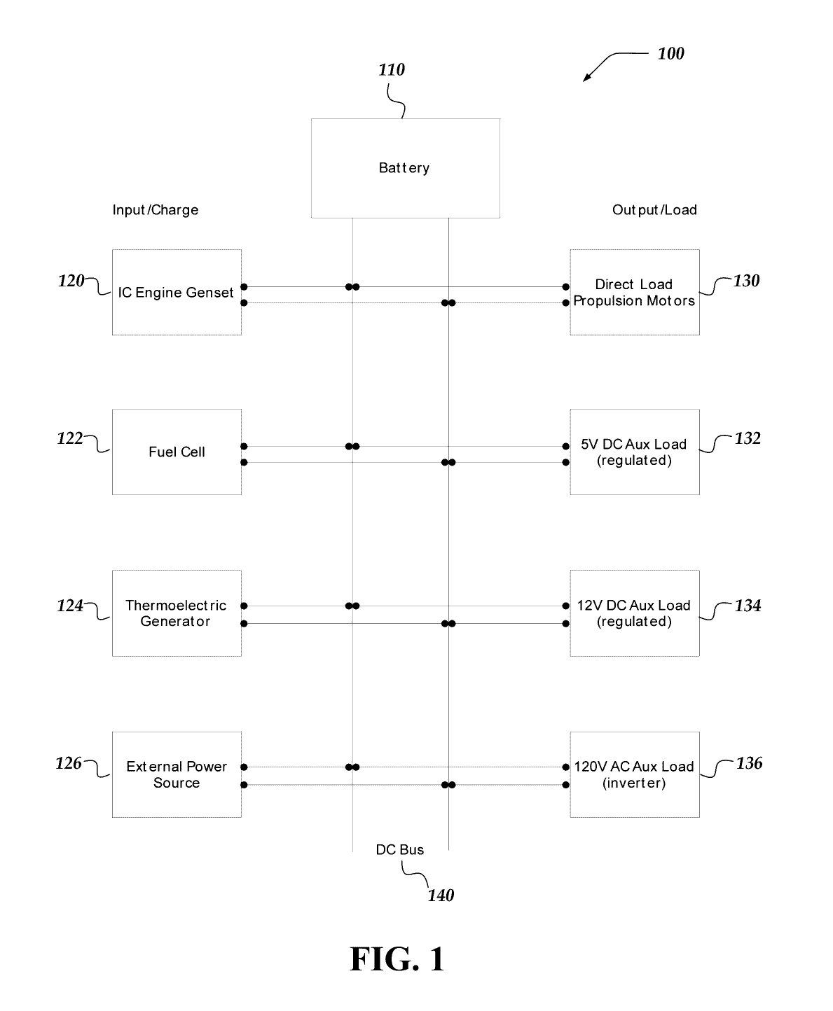

The operation of certain aspects of the invention is described below with respect to FIGS. 1-8.

FIG. 1 is a generalized block diagram that illustrates the flow of energy between input or charging elements, a battery and output or load elements in a hybrid power supply for a multirotor rotorcraft 100 (henceforth referred to as HPSM 100). Generally, HPSM 100 is a hybrid energy supply for a multirotor rotorcraft, a drone, a robot, or other moving electronic device. In some cases, HPSM 100 is a complete solution and includes a battery 110 and in other cases HPSM 100 acts to provide a recharging solution for a battery 110 provided by the multirotor rotorcraft, drone, robot or other moving electronic device. Thus, in certain embodiments, battery 110 is part of the subject invention and in other embodiments, battery 110 is external to and interfaces with the subject invention.

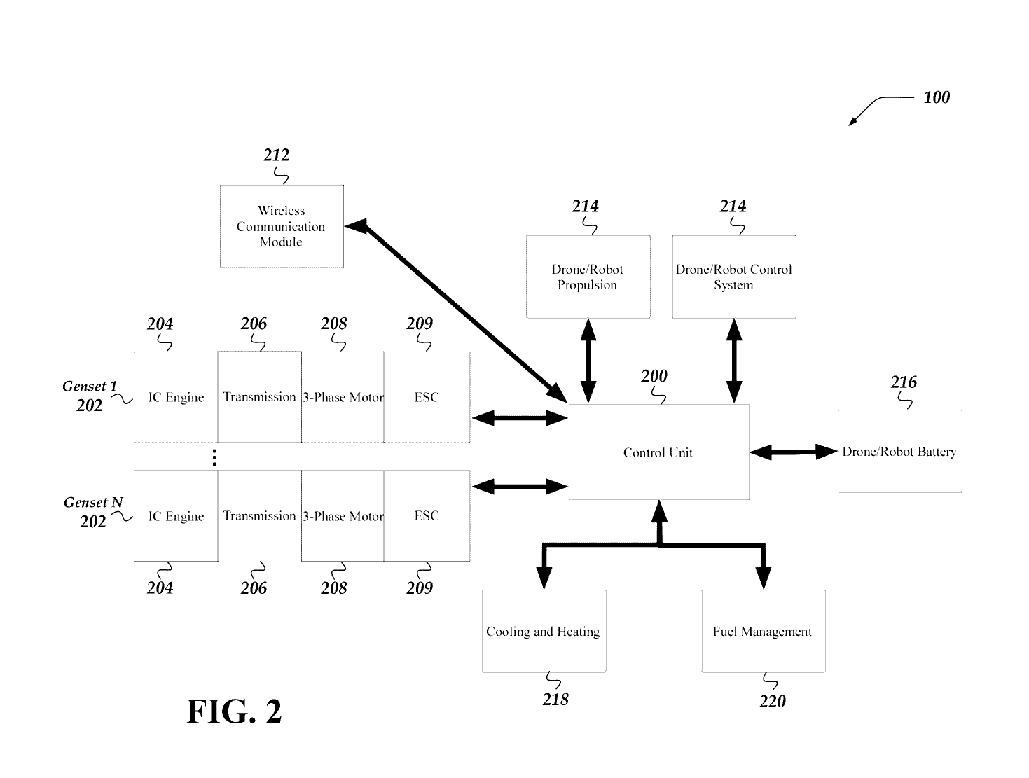

HPSM 100 includes one or more input or charge elements that generate electricity. The input elements illustrated in FIG. 1 are an internal combustion (IC) engine genset 120, a fuel cell 122, a thermoelectric generator 124, and an external power source 126. Additional input or charging elements may be included and different input elements from those depicted in FIG. 1 may be included without departing from the scope and spirit of the subject invention. In general, the input elements generate or supply a DC electric current into a DC bus 140 that is controlled by a control unit, described in further detail with reference to FIG. 2. The current may be used to charge a battery 110 or may be supplied directly to one or more output or load elements, depicted along the right side of FIG. 1.

The output or load elements identified in FIG. 1 are one or more direct load propulsion motors 130, henceforth referred to as motor 130, a 5 volt DC auxiliary load 132, a 12 volt regulated DC load 134 and a 120 volt alternating current (AC) load 136. Typically, the principal output element is motor 130, which is a motor provided by a commercial multirotor rotorcraft that HPSM 100 is supplying electric power to. As with the input elements, more or less different output elements may be implemented without departing from the scope and spirit of the subject invention. Further, in certain embodiments output or load elements such as motor 130 may be included in the subject invention, while in other embodiments output or load elements are outside the subject invention.

Further, the voltage of the various output elements does not need to correspond to the voltage of battery 110.

In certain embodiments, battery 110 refers to a battery provided by a multirotor rotorcraft, in which case battery 110 is outside the subject invention, i.e. it is external to HPSM 100. In other embodiments, battery 110 is included in HPSM 100. Each of these various embodiments is within the scope and spirit of the subject invention.

Battery 110 may use any battery chemistry, eg. LIPO, LIFE and may operate at any voltage. Generally, battery 110 is illustrated at the center of FIG. 1 to illustrate its central role. In most operating scenarios, input elements 120-126 charge battery 110 and battery 110 supplies power to output elements 130-136. Further, battery 110 may be implemented as one or more physical batteries.

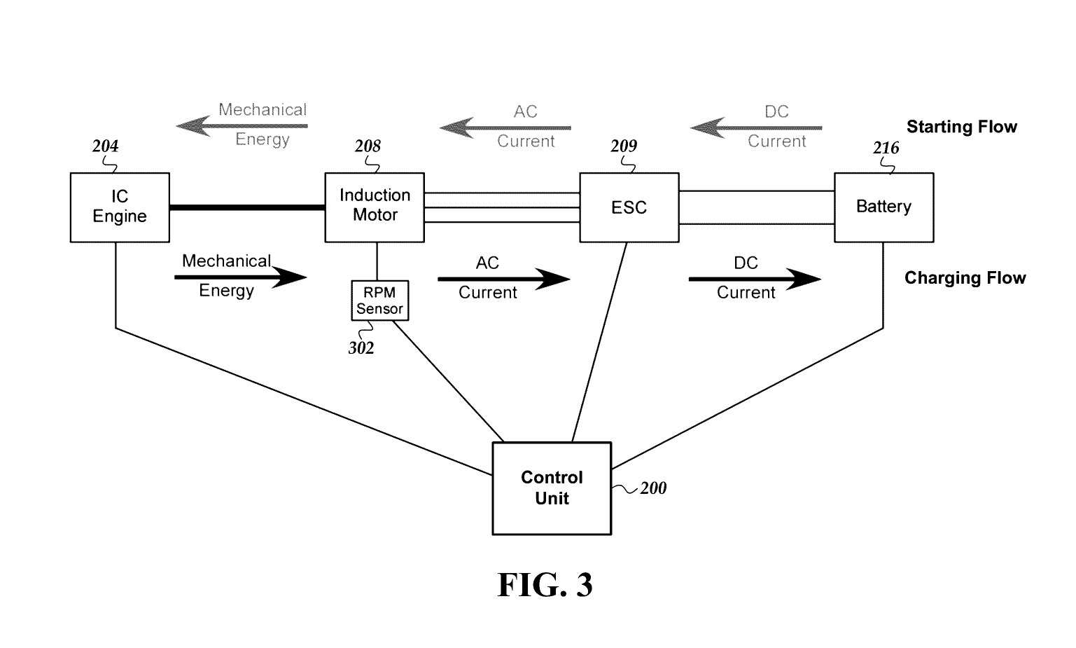

It may be appreciated by one skilled in the art, that the architecture depicted in FIG. 1 is substantially different than prior art power solutions for multirotor rotorcraft. Generally, the subject invention enables output elements 130-136, to operate independently from power generation, represented by input/charge elements 120-126. In fact, energy production can be entirely halted, or disconnected via a quiet mode, described in further detail with reference to FIG. 3 herein below. Further, typical power supplies for multirotor rotorcraft exclusively use batteries, whereas HPSM 100 offers a hybrid solution that also incorporates obtain input power from IC engine genset 120, fuel cell 122, thermoelectric generator 124 or another external power source 126. For example, use of an internal combustion engine such as that provided by IC engine genset 120 uses a fuel such as gasoline or ethanol that has a much higher energy power density than typical batteries.

FIG. 2 is a generalized block diagram that illustrates the operation of HPSM 100 from the perspective of a control unit 200. Generally, control unit 200 manages an arbitrary number of different types of input/charge elements, as previously described with reference to FIG. 1. FIG. 2 illustrates an embodiment in which there are N input elements, represented as genset 1 202 and genset N 202, i.e. each genset is referred to as genset 202. Genset 202 can be considered as one or more instances of IC engine genset 120; alternatively, IC engine genset 120 can be considered as representing one or more instances of an IC engine genset. For purposes of FIG. 2, genset 202 refers to an internal combustion engine, referred to as IC engine 204, together with a transmission 206 that provides the mechanical connection to a 3 phase motor 208, and a 3-phase electronic speed control (ESC) unit, referred to herein as ESC 209, which is capable of serving as a starter for the engine and a generator that provides DC current. Generally, IC engine 204 burns fuel to rotate an axle and transmission 206 provides gearing to change the torque and rotational speed delivered to motor 208.

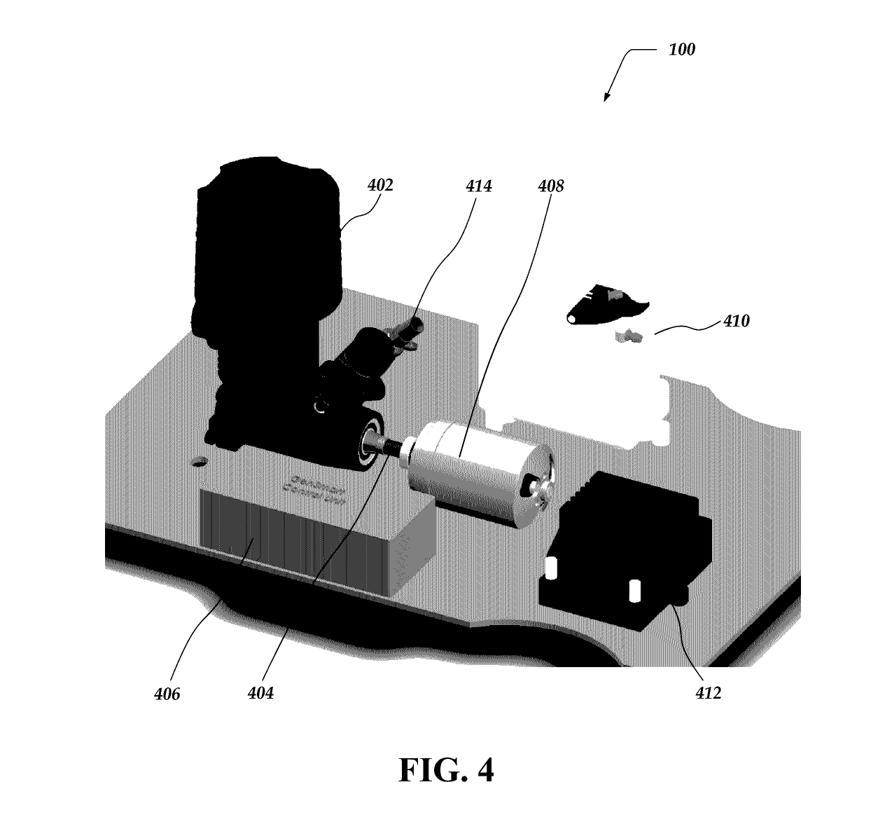

One unique aspect of genset 202, as further illustrated in FIG. 4, is that a single element, ESC 209, both starts the engine and generates DC power. In contrast, prior art systems typically employ two different elements or subsystems to accomplish these two functions: one system for starting the motor and a separate system for generating electricity by capturing the rotational power of the engine. For example, prior art motor control systems for both vehicles and generators typically employ two separate systems: (1) a starter motor to start the engine, and (2) an alternator to generate electric power needed by the vehicle or other load. The subject invention, is the first to use an ESC 209 in a bi-directional mode, thus eliminating the need for separate motors and their respective circuitry. This results in a smaller and lighter device. Unique control logic performed by control unit 200 manages ESC 209 to always be in the correct mode and ensures the proper flow of current to the motor (for starting) and from the motor (to charge the battery or supply the loads as necessary) during the operation of HPSM 100.

ESC 209 is managed by control unit 200 in such a way as to manage the back EMF in a way that allows current to flow through the ESC negative to the original design direction. This is accomplished through the synchronization of the frequency of the induction motor output wave and the ESC output wave. The induction motor output frequency is directly proportional to the shaft RPM which is adjusted by controlling the IC engine's throttle position. The output frequency of ESC 209 is controlled by adjusting the PWM input signal. The RPM of the engine is increased to induce current flow out of the induction motor through ESC 209, which converts it to DC to charge the battery or power loads. The engine RPM, AC frequency and DC current flow is continuously monitored to ensure that frequency sync is maintained and back EMF exceeds ESC 209 voltage to ensure current flow out of ESC 209 to battery 216 and/or other loads.

FIG. 2 illustrates a single output/load element, namely battery 216, labeled drone/robot battery 216. More generally, control unit 200 is capable of managing an arbitrary number of batteries 216. As previously discussed, battery 216 may be a part of HPSM 100 or may be external to HPSM 100.

More generally, control unit 200 manages current flow to one or more output/load elements 130-136.

Control unit 200 supervises the delivery of power from battery 216, gensets 202 and any other input/charge elements to output/load elements. To accomplish this, control unit 200 interacts with a cooling and heating element 218, a fuel management element 220 and a wireless communication module 212 to ensure the safe, reliable and efficient operation of all systems.

Control unit 200 includes a computer processor, nontransitory memory for storing data and program code. It further includes sensors, and heating and cooling control logic as required.

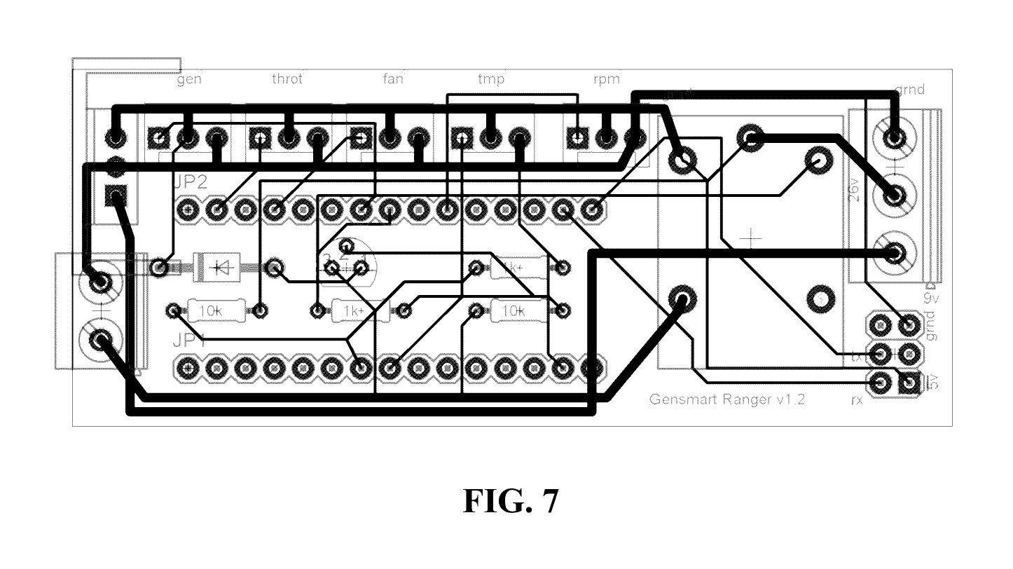

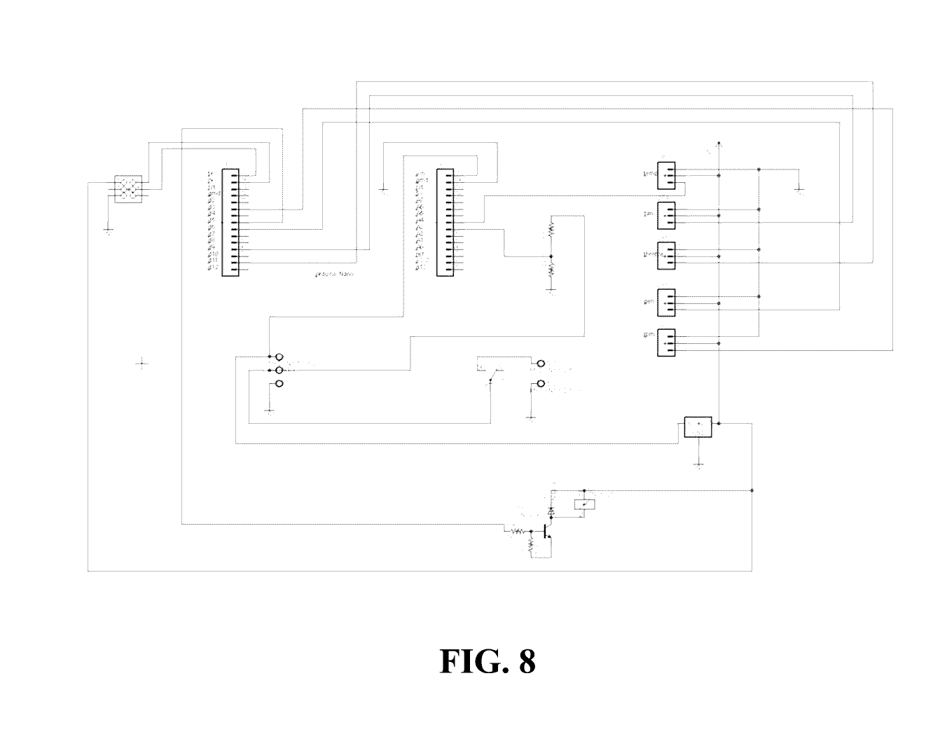

One example of an integrated circuit board layout of control unit 200 is given in FIG. 7. Further, one example of an electronic circuit design that implements control unit 200 is given in FIG. 8.

Cooling and heating elements 218 provide heating elements and cooling elements such as fans that maintain the necessary temperature levels required of the various hardware components in HPSM 100. Control unit 200 actively controls heating and cooling elements 218. Heating elements may include resistance wire, or other resistance elements that are controlled electronically by control unit 200. Cooling elements may include fans of various sizes that are likewise controlled by control unit 200.

Fuel management element 220 refers to the various mechanisms that dynamically adjust the fuel mixture and flow of air and fuel to the engine, also referred to as throttle. In one embodiment, fuel management element 220 uses servos to perform these adjustments. Fuel management element 220 regulates mixture and flow of any fuel required by any of input/charge elements 120-126, such as genset 120 and thermoelectric generator 124. For example, if genset 120 is under a relatively light load then a leaner fuel to air mixture may be used to reduce fuel consumption. Generally, fuel management element 220 adjusts fuel to air mixture to minimize fuel usage given the output power requirements.

Fuel management element 220 also senses the fuel level and provides the information to control unit 200. This is critical to avoid letting the engine run out of fuel; typically the fuel mixture is gradually reduced, or throttled back, prior to stopping the engine.

It may be appreciated by one skilled in the art, that control unit 200 working in coordination with fuel management element 220 and cooling and heating element 218 provides an active, intelligent approach to managing the generation and consumption of power in a hybrid power supply.

Wireless communication module 212 enables control unit 200 to communicate with an external controller, such as a remote control unit, or a mobile device or other control device. Wireless communication module 212 may support a variety of communication methods such as BLUETOOTH, WIFI, and GSM.

Wireless communication module 212 enables control unit 200 to receive commands from an external controller and to send status information to an external controller. Status information that may be provided includes charge level of battery 206, the load drawn by output/load elements, and level of the fuel tank(s). Commands received from wireless communication module 212 and processed by control unit 200 include setting operation to quiet mode.

FIG. 3 illustrates the flow of current during a starting sequence and a charging sequence as performed by an electronic speed control (ESC) as managed by control unit 200, according to one embodiment of the subject invention. To start IC engine 204, ESC 209 draws DC current from battery 216, converts the DC current to 3-phase AC current that flows to induction motor 208, which converts the AC electrical current to mechanical energy, typically in the form of rotation of an axle. Induction motor 208 is coupled to IC engine 204 and thus the mechanical energy is used to start IC engine 204.

In a charging sequence, ESC 209 draws AC current from IC engine 204 via the induction motor 208 and converts the current to DC and supplies the DC current to battery 216 for purposes of charging.

FIG. 4 is a simplified illustration of one embodiment of the physical layout of HPSM 100. As illustrated, HPSM 100 includes an internal combustion engine 402, a mechanical linkage or connection 404 to an electric motor 408, a control unit 406, a fuel tank 410, a 3 phase electronic speed control (ESC) 412, and a fuel intake valve 414.

Fuel intake valve 414 receives fuel from fuel tank 410 via a fuel line (not depicted). In certain embodiments a fuel pump or fuel injection system regulates the flow of fuel from fuel tank 410 to fuel intake valve 414.

While transmission 206 is depicted in FIG. 4 as a mechanical linkage without gears, in other embodiments transmission 206 may include gears or the like.

HPSM 100 may include a housing (not depicted) that encloses the various components described with reference to FIGS. 1-2. The housing may be made of carbon fiber, plastic or another material. In certain embodiments there is a user settable switch that enables a user to set HPSM 100 to quiet mode which prevents control unit 200 from turning on genset 202 to generate power to battery 216. In other embodiments, when HPSM 100 is set to quiet mode then no input charge elements 120-126 are allowed to supply power to battery 110. In certain embodiments, there is a second switch that enables the user to turn HPSM 100 on and off. When HPSM 100 is set to off then the device halts and input charge elements 120-126 are blocked from supplying or generating power to battery 110 and battery 110 is blocked from supplying power to output/load elements 130-136.

While FIG. 4 illustrates one shape and design for HPSM 100, in fact the invention is not so limited and other shapes can be used without departing from the scope and spirit of the subject invention. In a product form, there are likely to be different product sizes that offer varying amounts of power. For example, there may be a version that offers 1000 watt of power and another that offers 2000 watt of power. Generally, an output power in the range of 500-3000 watts is desirable. To accomplish this a fuel tank size in the range of 1000 to 4000 cubic centimeters (cc) is desirable.

The objective is for HPSM 100 fit in the size and weight envelope of a standard multirotor rotorcraft. Thus, in a preferred embodiment a weight range of substantially 0.5 to 3 kilograms is desirable. Further, dimensions of HPSM 100 should be relatively small. Thus, in a preferred embodiment width, height and depth dimension sizes in the range of 6″ to 18″ are desirable and sizes in the range of 6″ to 12″ per side are preferred.

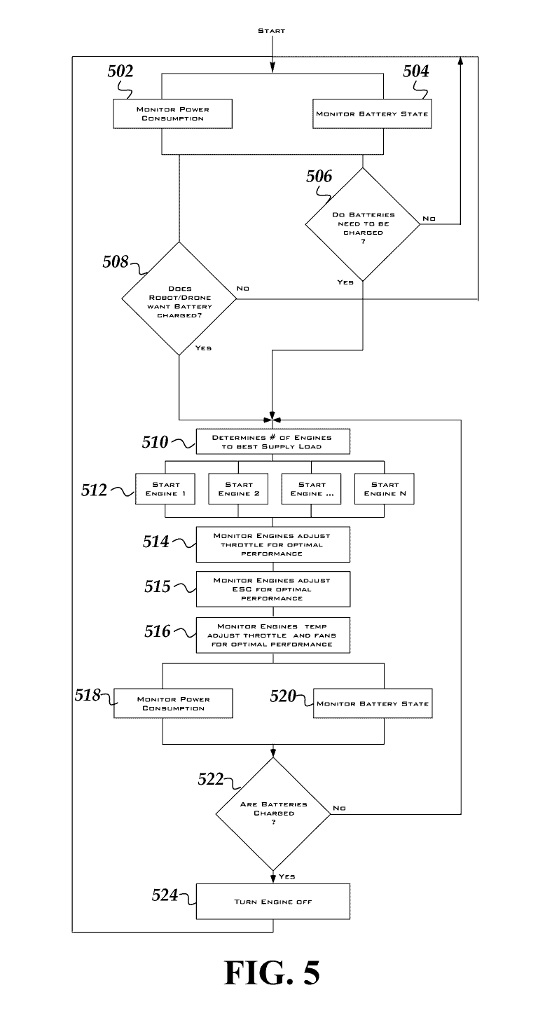

FIG. 5 is a flow diagram that provides an exemplary overall method used by control unit 200 of HPSM 100. After HPSM 100 is switched on or started, at step 502 control unit 200 checks monitors power consumption and at step 504 monitors or checks the state of battery 216. If may be appreciated, that battery 216 may in fact be implemented as one or more physical batteries. At step 506 a determination is made as to whether battery 216 needs to be charged, i.e. whether the remaining power level is above a threshold level. If battery 216 doesn't need to be charged then control returns to the start state and steps 502 and 504 are repeated. Note that steps 502 and 504 are depicted as being performed in parallel, whereas they can also be performed sequentially and can be performed in the reverse order.

If at step 506 it is determined that battery 216 needs to be charged then processing flows to step 510. If at step 506 it is determined that battery 216 is not too low then control returns to the initial state and steps 502 and 504 are performed.

At step 508 if an external control source, e.g. a multirotor rotorcraft or robot or an incoming command received via wireless communication module 212, wants to charge battery 216 then processing flows to step 510. If at step 508 no external control source has issued a command to charge battery 216 then processing returns to the initial state and steps 502 and 504 are performed.

At step 510, control unit 200 determines the number of engines, and which engines to use to recharge batteries 216. For example, if there are four batteries 216 in HPSM 100 then control unit 200 may determine to start batteries #2 and #4 based on various criteria.

At step 512 control unit 200 issues signals to the engines determined at step 510 to start.

At step 514 control unit 200 monitors the engines and adjusts the throttle opening (controls power production) and fuel/air mixture (controls lubrication and combustion temperature) to optimize fuel consumption and engine life for the current power output requirement and number of engines active.

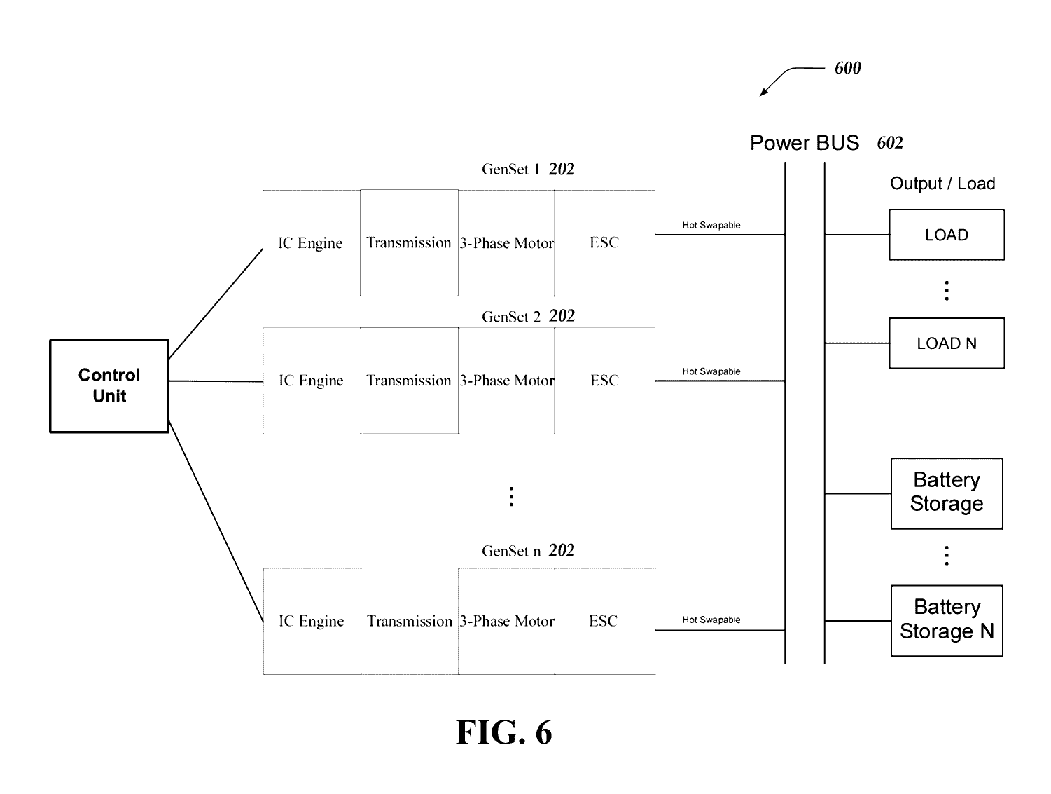

At step 515, control unit 200 monitors RPM and adjusts ESC 209 to properly manage current flow out of motor 208 through ESC 209 to battery 216, or as is discussed with reference to FIG. 6, hereinbelow, to a power bus that supplies DC power to one or more output/load elements.

At step 516 control unit 200 monitors the temperature of the engines that it has started and adjusts the fans for optimal performance. Furthermore, throttle opening and fuel/air mixture are again adjusted to protect engines. When operating limits are approached, power output is reduced to protect engines and extend component life.

At step 518 control unit 200 monitors the power consumption and at step 520 control unit 200 monitors the state of battery 216. Then, at step 522, this information is used to determine if the batteries are sufficiently charged. If not, control returns to step 510 to determine if the new current conditions require adjustments to the number of engines needed to operate. Temperature and fuel are also readjusted. This loop continues until the batteries reach a full state. If at step 522 a determination is made that battery 216 has been sufficiently charged then at step 524 the engines that were started at step 512 are turned off and control returns to the initial state.

FIG. 6 illustrates an embodiment of a hybrid power supply for a multirotor rotorcraft (HPSM) 600 that includes multiple gensets 202 connected in parallel to a DC power bus 602 to supply power to output/load elements such as batteries. Use of a power bus 602 enables each individual genset 202 to be hot swappable, i.e. capable of being individually inserted or removed from HPSM 600 while a multirotor rotorcraft is running, without causing damage or affecting performance. This innovation allows for multiple gensets to be managed by the control unit 200 to best meet the power demands of the loads. Individual gensets can be turned on and off during operation to handle loads, to rotate operation, to enhance durability and reliability, to optimize fuel economy and to facilitate maintenance.

It will be understood that each step of a flow description need not be limited in the ordering shown in the illustrations or described above, and might be performed in any ordering, or even performed concurrently, without departing from the spirit of the invention. It will also be understood that each step, and combinations of steps can be implemented by computer program instructions. These program instructions might be provided to a processor to produce a machine, such that the instructions, which execute on the processor, create means for implementing the actions specified in the steps. The computer program instructions might be executed by a processor to cause a series of operational steps to be performed by the processor to produce a computer implemented process such that the instructions, which execute on the processor to provide steps for implementing the actions specified in the illustrated or described step or steps.

Accordingly, steps of the flow illustration support combinations of means for performing the specified actions, combinations of steps for performing the specified actions and program instruction means for performing the specified actions. It will also be understood that each step of the flow illustration, and combinations of steps in the flow illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter.

What is claimed is:

1. Hybrid power system for multi-rotor drones that can provide supplemental or surplus (charge) power and comprised of:
an internal combustion engine with a size of under 10 cc;
a 3-phase induction motor that is mechanically connected to the engine;
an electronic speed control that is electrically connected to the motor; and
an electronic control unit that manages the electronic speed control in such a way as to: (1) allow the electronic speed control to convert DC to AC when starting the engine and (2) to convert AC to DC when charging.

2. The hybrid power system of claim 1, wherein the electronic control unit is further capable of power management while simultaneously managing engine throttle, electronic speed control, cooling system and communications.

3. The hybrid power system of claim 1, wherein the weight of the hybrid power system is less than 1.8 kg

4. The hybrid power system of claim 1, wherein the power output is less than 1.8 kW.

5. The hybrid power system of claim 1, wherein the ESC is managed by the ECU in such a way as to manage back EMF in such a way that allows current to flow through the ESC negative to the original design direction.

6. The hybrid power system of claim 1, wherein N gensets, are connected to a DC power bus, enabling each of the N gensets to be individually activated, deactivated, connected or disconnected independent of the other gensets and without disruption of the entire's systems operation and ability to supply power, and wherein each genset comprises an engine, an induction motor and an ESC,

7. The hybrid power system of claim 1, wherein a multi-tasking multi-processor architecture methodology is applied to power production where 1-N engine sets are used and the ECU decides how best to manage, use and cycle the gensets in order to concurrently meet power demands, increase efficiency and extend system durability.

8. The hybrid power system of claim 4, wherein engine sets become hot swappable to form a system where most maintenance can be performed without system shut down and reliability increases because the genset is eliminated as the single-point-of-failure.

9. The hybrid power system of claim 1, wherein the engines can be started or stopped at anytime during flight by the on-board flight control, remote control system or through programmed waypoints, altitude parameters or other data point.

10. The hybrid power system of claim 1, wherein the electronic control unit sends telemetry data to a cloud system. Data can be accessed by a ground control system live to be used to provide a feed back loop.

11. The hybrid power system of claim 1, wherein the output of the system is greater than or equal to 800 watts per kilogram.

12. The hybrid power system of claim 1, wherein the system incorporates a piston internal combustion engine operating at more than 20,000 RPM.

13. The hybrid power system of claim 1, wherein the system incorporates a compression ignition piston internal combustion engine.

14. The hybrid power system of claim 1, wherein the N gensets can be located disjointedly so as to allow placement on the flying craft in such a way as to improve weight distribution and thereby flying performance.
